(19) United States
(12) Patent Application Publication
(10) Pub. No.: US 2008/0251373 A1
(43) Pub. Date: Oct. 16, 2008

(54) Potable Water Purifier For Pressurised Systems For Buildings

(75) Inventor: Simon Forbes Oke, Kilburn (AU)

Correspondence Address: AKERMAN SENTERFITT, P.O. BOX 3188, WEST PALM BEACH, FL, 33402-3188, US

(73) Assignee: Ecozone Pty. Ltd., Wingfield (AU)

(21) Appl. No.: 11/577,686

(22) PCT Filed: Oct. 21, 2005
(86) PCT No.: PCT/AU05/01636

§ 371 Date: Mar. 7, 2008

(30) Foreign Application Priority Data
Oct. 21, 2004 (AU) 2004906072

(51) Int. Cl. C02F 1/04

(52) U.S. Cl. 203/11

(57) ABSTRACT

A system of purifying water in a pressurised system using a venturi to contact a chemical with the water, the system having a main water line from inlet (5) to faucet (15) and including a bypass loop (13) incorporating the venturi (6) to add the chemical to the water, a pump (12) in the bypass loop (13) to pass water through bypass loop (13) at constant pressure whereby the venturi (6) delivers the chemical at a constant rate irrespective of the variation of water pressure in the main water line (5) due to opening and closing of the faucet.

Potable Water Purifiers are products which control pollutants in water which may be consumed by humans or animal. The pollutants may include micro-organisms (including bacteria, viruses, protozoa, algae, fungi, biofilm), organic matter, salts, metals, solids etc. Potable water includes tap water for houses, hot water systems, bathing water, rainwater tanks etc. Purification methods may include chlorination, filtration, oxidation, etc.

Water may be purified at a central treatment plant from which it is then pumped to mains pressure and distributed to buildings, which is the method used by municipal authorities. Or water may be purified close to the “end of pipe”, such as at buildings, which may include houses and offices. “End of pipe” water purifiers include low-pressurised systems or non-pressurised systems which are located either near the tap faucet in the building or are filled with water from it, such as kitchen counter tap filters, evaporators, and other small devices. “End of pipe” water purifiers also include pressurised systems which operate in the vicinity of the building but just upstream of it (before water enters the building) and are therefore subjected to “mains pressure” from the distributed water supply by the municipal authority.

These pressurised purifier systems can comprise the purification device itself as well as pipework and pressure vessels downstream of the purification device. Pipework can include local distribution systems to deliver water to different uses in the building such as taps, showers, toilets, etc. Pressure vessels can include hot water storage tanks, solar panels, etc.

In the case of potable water purifiers located upstream of buildings, where upstream water pressure is mains pressure, the existing art is mainly restricted to filters of varying types. This art successfully controls relatively large pollutants, such as organic load and solids, but is either wholly or partly unsuccessful in the case of micro-organisms due to low kill rates for smaller micro-organisms such as bacteria and viruses.

The invention comprises a device for controlling a broad spectrum of pollutants including all kinds of micro-organisms, to purify water so that it is potable or drinkable, and which is located at a building in a water system, where the supply water to the device is pressurised such as at mains pressure.

### PROBLEMS WITH EXISTING ART

One method of controlling waterborne micro-organisms at a building is to inject chemicals into the feedwater, including chlorine in liquid or gaseous form, shown in FIG. 1. The chemical is injected from a vessel or device 7 at injection point 6. When injecting chemicals into high pressure water, the technology must respond to a number of changing physical variables. (An example is repeatedly referred to throughout this patent description, which is a conventional hot water storage system for a domestic household). Water enters from the municipal system at location 1 shown in FIG. 1 (for example at mains pressure of 500 kpa). When the faucet 3 in the house is closed, the water pressure upstream is at maximum pressure (approximately 500 kpa for example). As the tank heats the water, thermal expansion occurs and the pressure increases (for example to 850 kpa). The following physical conditions may vary substantially:

a. When the tap is opened, water flows and there is a large pressure loss in the pipe 4 and at the exit from the faucet and this pressure loss approximately equals mains pressure.

b. The extent to which the faucet is opened (for example partially) changes the pressure loss and therefore the measured pressure at a set point in the pipe 4.

c. Multiple taps may be opened.

d. The mains supply pressure of the water which enters the pipe at 1 may vary due to demand in the suburb or due to maintenance work by the municipal authority.

Therefore, it is appreciated that the water pressure, downstream and upstream of point 6 where the chemicals from the purifier 7 contact the water, vary considerably. Therefore both the pressure and the flow rate vary considerably which makes it difficult or expensive to design or commission an effective purification device, where that device is a part of the pressurised system.

A popular and effective contact mechanism is a venturi. However, venturis, such as Mazzei venturis have a small operating range of pressures and flows, over which they operate effectively. It is well known, that when pressures and flows fluctuate, as in the example described, they fail to operate efficiently, or may even fail to mix any liquid or gaseous chemical into the water whatsoever.

A further problem with a venturi, in the case of contacting a gaseous chemical with water (eg gaseous oxidants) is that the gas can build up in downstream pressure vessels (eg a hot water tank 2) and/or recirculate back to a water pump. If a chemical dosing pump is used as the contact mechanism, a problem exists whereby tie volume of chemicals injected into the water does not respond to the volume of water flowing per time.

An existing art, which does not rely upon chemicals, is where water is heated (for example to 60° C.) in the tank 2 in order to kill microbes. However, this does not act to kill microbes in the downstream pipe 4.

Further, modern hot water systems often include tempering valves 8 where, after water is heated and leaves the tank at pipe 9, this hot water mixes with some cold water from pipe 10. The mixing occurs at valve 9 and thus warm water flows through pipe 4, to avoid scalding hazards at faucet 3. Many countries have implemented legislation to mandate such tempered systems, to reduce human injury caused by scalding. Therefore the cold water in pipe 10 (which for example makes up to 40% of total flow) bypasses the hot water tank and therefore bypasses the microbe killing device.

Tempered hot water systems are not energy efficient as they must first raise water temperature in the hot water tank 2 (for example to 60° C. minimum) to kill microbes such as legionella, and then reduce the temperature back again (for example to 45° C. maximum) by using a tempering or mixing valve 8. Further, water temperature in the tank stratifies (for example it may be 60° C. at the top and 35° C. at the bottom) which may create a warm water zone at an ideal temperature for growth of bacteria such as legionella, in the tank itself.

### OBJECTS

It is an object of the invention to overcome one or more of the above problems associated with the purification of water in high pressure systems.

A further object of the invention is to contact a disinfection chemical with the water, efficiently and consistently, independent of varying upstream and downstream pressures and flows.

A further object of the invention is that the disinfection chemical or process may be created by an ozone generator or alternatively by an advanced oxidation generator as described in any of Australian patent applications 2002344695, 2002257378, 2002336795 or their respective patents lodged in other countries.

### BRIEF STATEMENT OF THE INVENTION

Thus there is provided according to the Invention a method of purifying water in pressurised systems, including the steps of contacting chemical with water by using a venturi, where the venturi is in a water pipe loop which allows full recirculation of water flow within the purification device itself, where this recirculation flow is caused by a water pump and motor in the device, where the recirculation loop includes an inlet water pipe (from mains) and an outlet water pipe (to tap faucet) joined by a bypass pipe, where the flow direction in the bypass pipe can be in either direction or can be static depending on the mains flow rate, and where he bypass acts as a water/gas separator to reduce gas recirculating to he water pump, so that the venturi performance is optimal at all times.

There is also provided apparatus for injecting chemicals into the water either when maximum water is flowing (faucet open) or when water is static (for example the building occupiers are on holiday).

There is also provided apparatus for injecting gaseous chemicals into the water and then transporting this gas from the purification device to a pressurised tank, without any water flowing into the tank,

Also, there is provided according to the invention a method of injecting water which has been chemically purified by the device, through a single port or fitting of a tank and simultaneously sucking water from that same single port to recirculate water back to the device, thereby achieving consistent two way flow through one tank opening, including during times when the system is otherwise static due to all tap faucets being shut.

There is also provided a method of the chemical injected into the water being transported both to the pressure vessel and through a tempering valve to the pipework to the faucet, at the same time.

### BRIEF DESCRIPTION OF THE DRAWINGS

FIG. 1 is an example of a domestic hot water pressurised system,

FIGS. 2A, 2B, 2C and 2D are flow diagrams of the purification device connected to a pressure vessel,

FIG. 3 is a three dimensional drawing of one embodiment of the device,

FIGS. 4A, 4B and 4C illustrate the bypass flow rates,

FIG. 5 illustrates a flow switch component of the invention,

FIG. 6 illustrates the single port injection method, and

FIG. 7 illustrates the potted shell of the purification device.

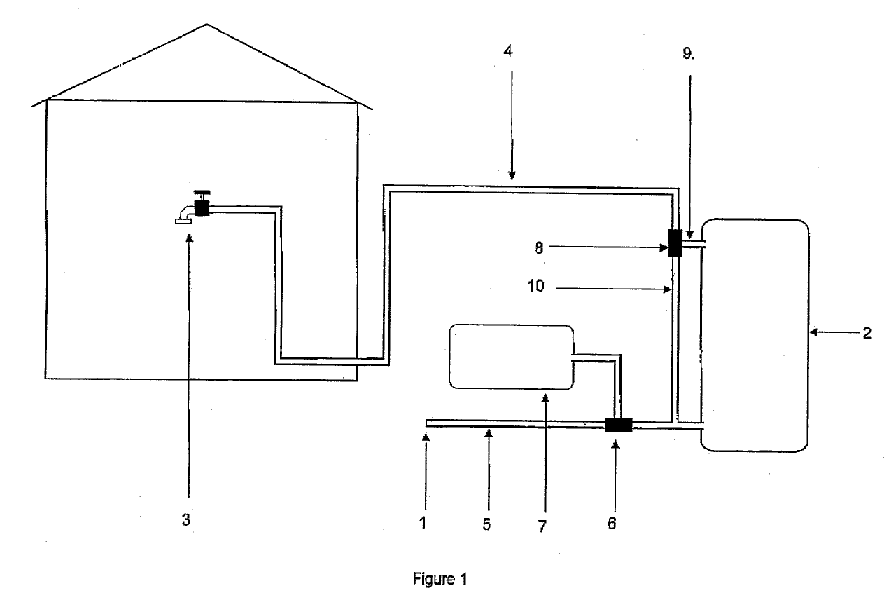

### DESCRIPTION OF THE PREFERRED EMBODIMENT

During the following description, examples of flow rates, pressures and other data are provided. An example is also provided of a hot water system. These examples are indicative only and are not to limit the scope of the invention.

Bypass Flow Rates

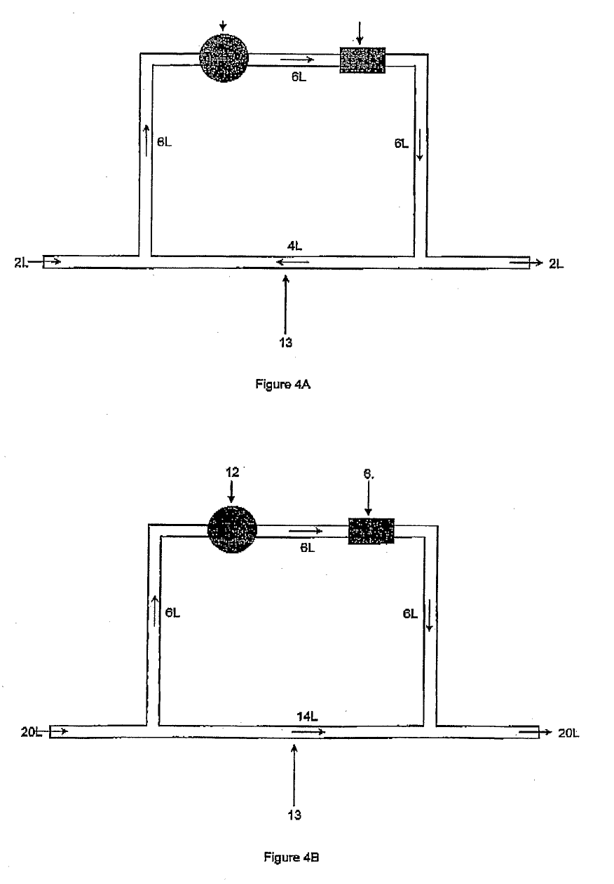

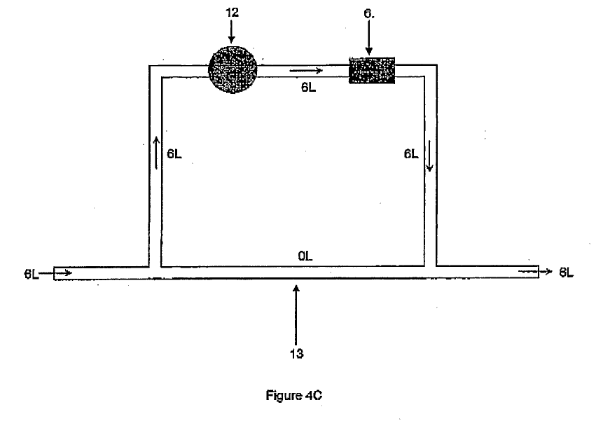

FIGS. 4A, 4B and 4C show a part of the pipework inside the device (not to scale). The water flow enters at the left and exits at the right in all 3 Figures. Also the water flow through the loop which contains the pump 12, is 6 l/min (for example) and is in the same direction for all 3 Figures. The difference amongst the 3 Figures concerns the entry flow rate (which equals the exit flow rate) and the resultant flow conditions (rate and direction) in the bypass 13.

FIG. 4A shows a relatively low faucet flow rate passing through the device (thus 2 l/min both entering and exiting the system). It can be seen that 4 l/min must flow through the bypass 13 in a direction which is from right to left. In this example the water in the recirculation flow passes the contact point (6) a multiple of times before exiting. In this example the device creates its highest levels of oxidation.

FIG. 4b shows a relatively high faucet flow rate passing through the device (for example 20 l/min). As water enters the vicinity of the bypass loop (13) the 20 l/min flow separates into a 14 l/min flow through the bypass (13) and a 6 l/min recirculation flow through the loop which is oxidised as it passes the contact point (6). The two flows rejoin and the 6 l/min flow of treated water mixes with the 14 l/min flow. Some dilution occurs and oxidant levels are lower than examples 4a or 4c. The flow direction in the bypass is from left to right.

FIG. 4c shows a medium faucet flow rate passing through the device, namely where that faucet flow rate equals the pump recirculation flow rate (being 6 l/min in the example). In this example the recirculation flow within the device is equal to the faucet flow so there is effectively no flow through the bypass. All of the faucet flow passes through the water pump (12) and the contact point (6).

Comparing the Figures it may be appreciated that the direction of flow in the bypass loop can be either direction (or can be static). This Innovative feature enables the recirculation flow within the device's loop to remain relatively steady (for example at 6 l/min) regardless of the faucet flow which passes through the device which may vary from zero to a large flow. Therefore a contact device such as a venturi may be located in the recirculation loop in the device, where that venturi is thus subject to relatively steady flows and pressures and therefore can operate within its efficient design range, regardless of the external system conditions (pressure and flow) varying substantially.

Delivery Mechanisms

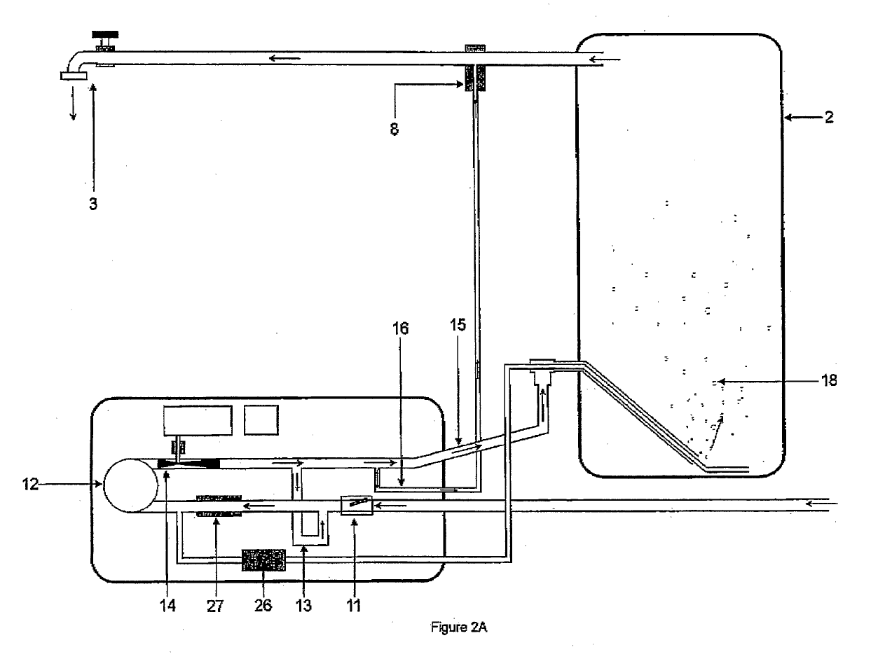

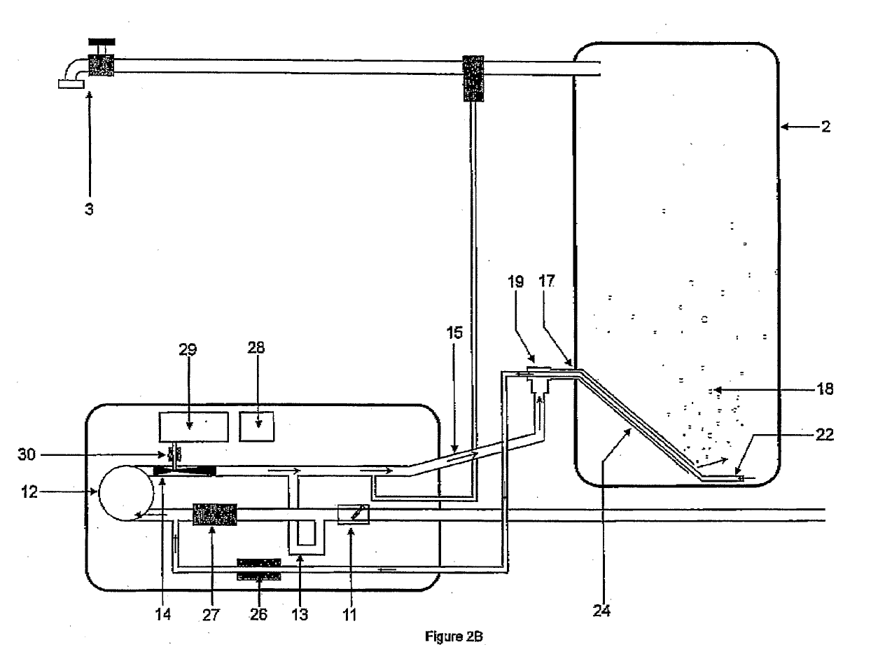

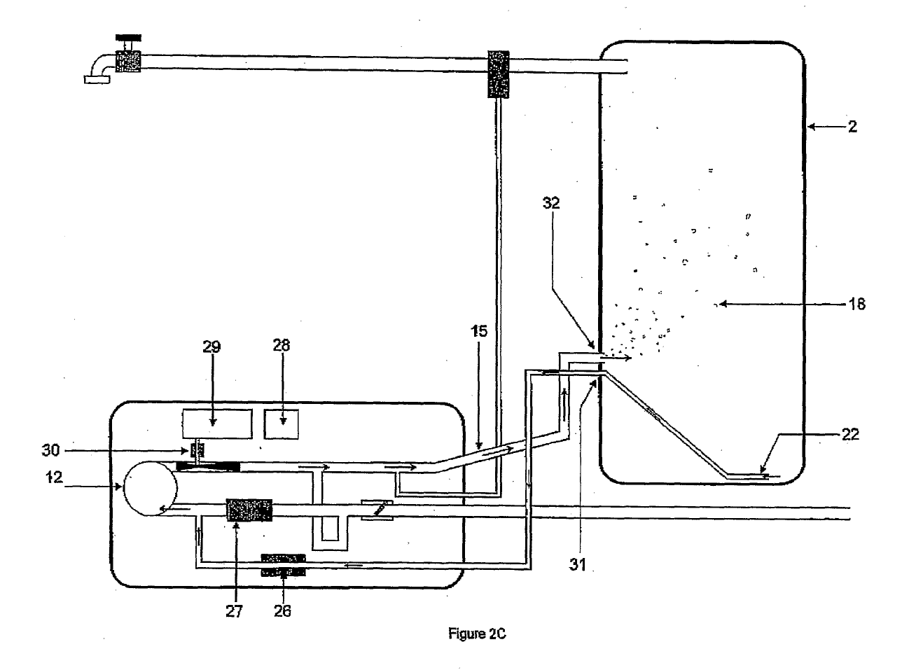

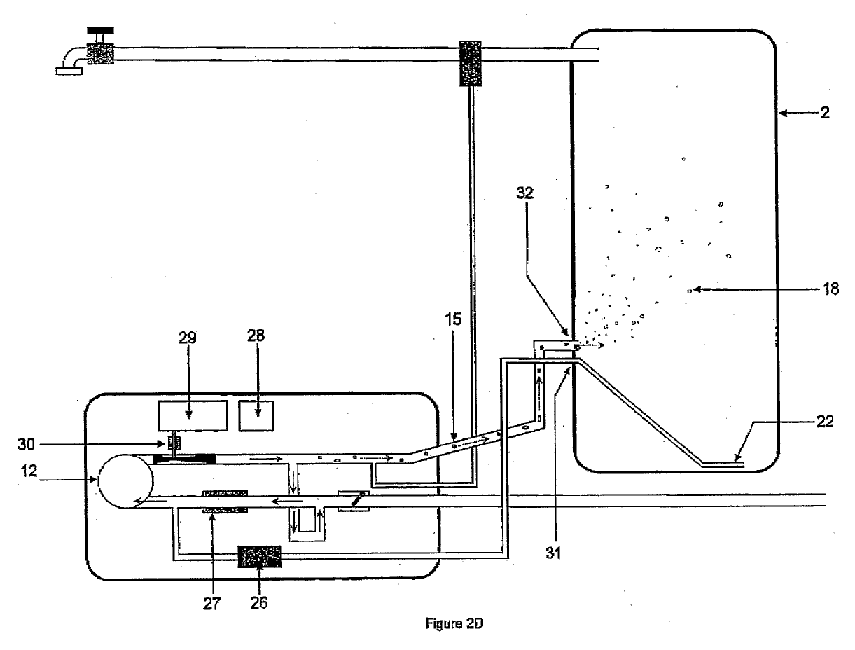

The invention includes four alternative mechanisms for the delivery of purified water to downstream pipework or to a downstream pressure vessel. These mechanisms are labeled as A, B, C and D in FIGS. 2A, 2B, 2C and 2D respectively.

Delivery mechanism A is used when the building occupier is “home” and has opened a faucet in the building in order to use a flow of water. This delivery mechanism is also used if a water valve is automatically operated, such as for water supplying a sprinkler system or an evaporative cooling system (in the case of the device connected to a point of entry system). Delivery mechanisms B, C & D are used when the faucet is shut and thus water is not entering or exiting the overall system. This occurs when the building is not occupied, or when it is occupied but the faucet is not being used an has not been used for some time. These latter three delivery mechanisms can be used for additional treatment of water which is stored in a downstream vessel, such as a hot water tank or a rainwater tank.

In the case of a pressurised hot water system, the four delivery mechanisms are typically as follows:

A. Normal operation with the faucet open when mains water flows into the hot water system.

B. Dormant with the building unoccupied and the device recirculating water (in and out, in both directions) through a single port on the storage tank.

C. Dormant with the building unoccupied and the device recirculating water through 2 separate ports on the storage tank.

D. Dormant with the building unoccupied and the device connected so the stored water is treated but no water is recirculated through the storage tank.

There are two reasons that water purification is beneficial or advantageous when water is not flowing from faucets, as now described.

First, when the building occupants are not present, such as during holiday periods, faucets are closed and water typically does not flow through the overall system. This situation may be described as “Holiday Mode”. In the case of a pressurised hot water system for example, the hot water elements may be left on or may be turned off. During the holiday period, small numbers of micro-organisms which were present in the water tank may breed and multiply, and will not be subjected to flushing because the water will be static or stagnant. When the occupants return from holiday they may choose to immediately use the hot water system, and thus although the purification device will then treat water which enters the system at that time, there will be a large quantity of water in the tank which has received no purification treatment since the time it entered the tank prior to the holiday period commencing. Therefore it is advantageous if the purification device can periodically “turn on” during the holiday period and treat the contents of the water tank, when the faucet remains turned off.

Second, in some buildings, hot water is predominantly used for short intervals or on an irregular basis. Examples include commercial buildings where no shower or bath exists. The purification device only treats the water while the faucet is open which in some cases may be only a few seconds, for example while rinsing a glass. Therefore the purification device is only treating water for this short period of time, whilst water is flowing in and out of the device. Therefore cumulative purification “on time” per day is small. In the example of a hot water system, when the faucet is turned on, hot water is introduced into the pipework which later cools and may create an ideal temperature profile for legionella growth in the pipework. The invention includes a rundown timer which keeps the device operating for a period of time after the faucet is closed (for example for 30 seconds). This situation may be described as “Run Down Mode”. This causes cumulative purification “on time” to increase. This is particularly beneficial in the case where the treatment chemical is ozone or related oxidant, where the chemical has a relatively short half life and its concentration quickly reduces after injection stops. Micro-organism kill rates are a function of the product of the concentration of chemical and the time for which such chemical is present (known as the CT product). Therefore, in the case of ozone or related oxidant, greater “on time” can result in significantly higher kill rates.

The Holiday Mode and Run Down Mode described above, in order to operate, require water to enter and exit the device, and thus to be purified, when the faucet is closed and there is no overall system flow. Delivery mechanisms B, C and D are the three alternative configurations which enable this to occur.

The detailed invention for each of the four delivery mechanisms (A, B, C and D) will now be described by referring to FIGS. A, B, C and D respectively.

Delivery mechanism A: In Normal operation the mains water flow rate through the hot water system is controlled by how far the hot water faucet is opened. The device has a flow switch (11) which starts the device whenever the mains water flow rate exceeds 2 L/min for example. Within the device the water pump (12) and venturi (14) are connected to the mains water flow through a bypass (13). The bypass (13) allows the water pump (12) to circulate water through the venturi (14) at a relatively constant rate irrespective of the mains water flow rate. This allows consistent venturi performance and gaseous oxidant injection rates at all mains water flow rates greater than 2 L/min for example. The bypass (13) connection to the outlet pipe (15) forces the water entering the bypass loop (13) to travel vertically downwards. This separates any undissolved oxidant bubbles (18) so that only liquid returns to the water pump inlet. The bubbles exit the device through the outlet pipe (15) and enter the hot water tank (2) where they further treat the stored water as they rise to the surface. When the faucet on a conventional pressure storage hot water system is opened some level of dilution with cold water occurs automatically to avoid accidents such as scalding. The level of dilution is controlled by the tempering valve (8) on the hot water tank. The water required for this dilution is also treated by the device. The water exits the device through the tempering valve outlet port (16). This port is also connected to the outlet pipe (15) so the exiting flow is vertically downwards and thus does not transport oxidant bubbles to the tempering valve (B). So in normal operation or faucet open mode the device treats all of the water entering the hot water system and also treats the internal surfaces of the hot water tank (2), solar panels and associated pipework in the building.

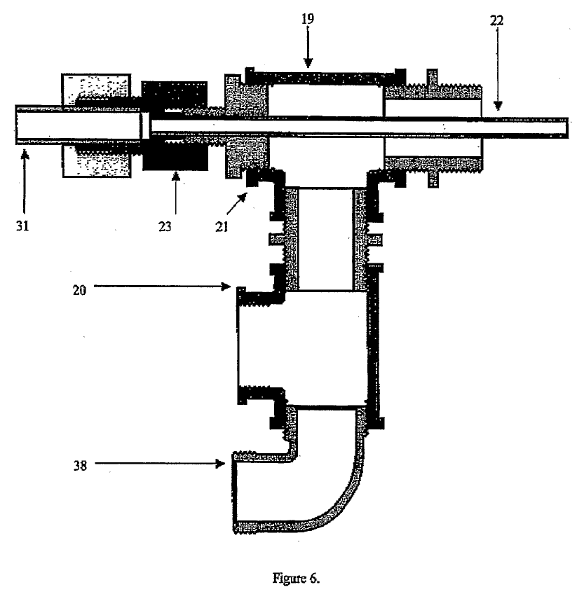

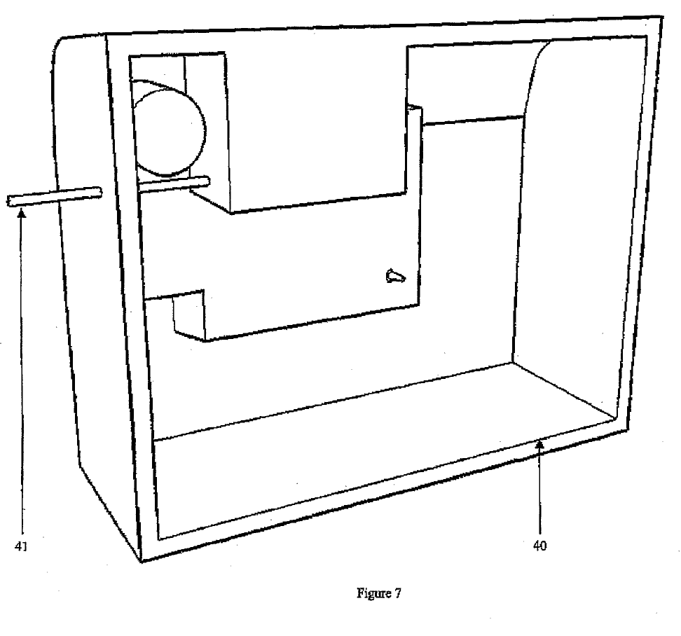

Delivery mechanism B: When the building is not occupied and the hot water system is dormant the device will continue to periodically treat the stored water to eliminate any microbe or biofilm regrowth. When the device is connected to the hot water tank (2) using a single port (17) where bath the mains flow enters the tank and treated recirculation flow enters and exits the tank through a single tank port (17). Recirculation through the hot water tank (2) is achieved by connecting a tee fitting (19) to the single tank port (17). Referring also to FIG. 6, the right angle port (20) of the tee fitting (19) is connected to the outlet port (15) on the device. A flexible tube (22) and tube adaptors (23) are fitted to the inline port (21) of the tee fitting (19). The flexible tube (22) length is sufficient to protrude approximately 100 mm from the end of the dip tube (24) inside the hot water tank (2). The inline port (21) is then connected to the hot water return port (25) on the device. Recirculation water flow is controlled by the hot water solenoid (26) and the mains water solenoid (27). The recirculation water flow is activated by a rundown timer (28) in the device which starts each time the flow switch (11) contacts open as the faucet (3) closes during normal operation. When the time interval between faucet openings is greater than the rundown timer (28) setting the device periodically, for example for 5 minutes every 48 hours, closes the mains water solenoid (27) and opens the hot water solenoid (26) and operates the water pump (12), oxidant emitters (29), gas solenoid (30) etc. The device draws water out of the hot water tank (2) through the flexible tube (22), treats the water and returns the treated water to the hot water tank (2).

Delivery mechanism C: When the building is not occupied and the hot water system is dormant the device will continue to periodically teat the stored water to eliminate any microbe or biofilm regrowth. When the device is connected to the hot water tank (2) using two tank connection ports being the recirculation suction port (31) and the recirculation return port (32). The recirculation suction port is connected to the hot water return port (25) and the recirculation return port (32) to the outlet port (15) on the device. Recirculation water flow is controlled by the hot water solenoid (26) and the mains water solenoid (27). The recirculation water flow is activated by a rundown timer (28) in the device which starts each time the flow switch (11) contacts open as the faucet (3) closes during normal operation. When the time interval between faucet openings is greater than the rundown timer (28) setting the device, periodically for example for 5 minutes every 48 hours, closes the mains water solenoid (27) and opens the hot water solenoid (26) and operates the water pump (12), oxidant emitters (29), gas solenoid (30) etc. The device draws water out of the hot water tank (2) through the recirculation suction port (31) treats the water and returns the treated water to the hot water tank (2) through the recirculation return port (32).

Delivery mechanism D: When the building is not occupied and the hot water system is dormant the device will continue to periodically treat the stored water to eliminate any microbe or biofilm regrowth by introducing oxidant bubbles into the hot water tank (2) through the outlet port (15) without recirculating water through the hot water tank (2). To achieve this the outlet port (15) on the device must be sloping upwards. It is shown as sloping upwards in all of FIGS. 2A to D, but it is only necessary that it slopes upwards for delivery mechanism D as shown in FIG. 2D. The sloping pipe 15 is connected to the hot water tank (2) via the recirculation return port (32). The hot water return port (25) on the device is plugged and inoperative. Treatment of the hot water tank (2) is activated by a rundown timer (8) in the device which starts each time the flow switch (11) contacts open as the faucet (3) doses during normal operation. When the time interval between faucet openings is greater than the rundown timer (28) setting the device periodically, for example for 5 minutes every 48 hours, closes the mains water solenoid (27) and operates the water pump (12), oxidant emitters (29), gas solenoid (30) etc. The oxidized water returns to the water pump (12) inlet port through the bypass loop. The bypass (13) connection to the sloping outlet pipe (15) forces the water entering the bypass loop (13) to travel vertically downwards. This separates any undissolved oxidant bubbles (18) so that only liquid returns to the water pump inlet. The bubbles then exit the device through the sloping outlet pipe (15), due to be physical effect of buoyancy, and enter the hot water tank (2) where they treat the stored water as they rise to the surface. Thus oxidant enters the tank (in the gas phase as bubbles) and yet no water flow enters the tank, and no water flow enters or exits the overall system, for delivery mechanism D.

Bypass Loop Acts as a Gas Separator

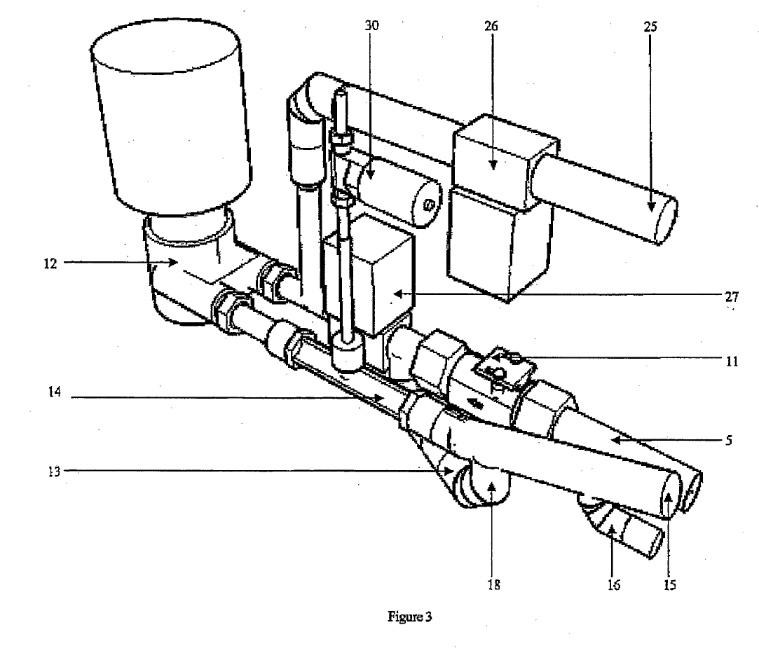

FIG. 3 shows the bypass (13) connecting the mains supply pipe (5) to the outlet port (15). This is also shown in FIG. 2D in the case of delivery mechanism D. In the case of the treatment chemical being gaseous, such as ozone or other oxidant, the bypass also serves an additional purpose as a separator for undissolved oxidant bubbles. When the recirculating water is returning to the water pump (12) and exits the sloping outlet port (15) the recirculated water turns vertically downwards. This vertical flow separates the undissolved oxidant bubbles (18) which float and travel along the highest path and so continue to travel along the sloping outlet port (15) and are separated from the recirculation flow. This maximises the oxidant levels in the hot water tank (2) and minimizes undissolved oxidant bubbles reentering the water pump (12).

The Gas Separator also operates effectively in the case of the other three delivery mechanisms, namely mechanisms A, B and C shown respectively in FIGS. 2A, 2B and 2C. This means that bubbles exit through the relevant outlet port and do not re-enter the pump 12, which ensures that the pump does not cavitate and also ensures that the venturi contactor operates efficiently.

Oxidised Water can Treat Pipework Also

Modern hot water systems include a tempering valve (8) that automatically mixes water from the hot water tank (2) with the correct amount of cold mains water to achieve a preset hot (or warm) water temperature at the faucet delivery pipe (4) (for example 45 degrees C.). This minimises the risk of accidental injury from scalding. In modern hot water systems the current art for legionella control is to heat and store the water at a temperature greater than 60 degrees C. This successfully treats the stored hot water but has no affect on the old mains water which bypasses the tank through pipe 10 and is supplied to the tempering valve (8). In the worst case of, for example 30 degrees C. temperature for the cold mains water, the mixing ratio in the tempering valve may be close to 50:50 meaning that approximately 50% of the hot water output from the faucet is untreated.

FIG. 3 shows the location and detail of the tempering valve outlet port (16) within the device. As treated water within the device exits the sloping outlet port (15) and enters the tempering valve outlet port (16) the water turns vertically downwards. This vertical flow separates the undissolved oxidant bubbles (18) which float and travel along the highest path and so continue to travel along the sloping outlet port (15) and are separated from the treated water going to the tempering valve (8). The Gas Separator also operates effectively in the case of the other three delivery mechanisms, namely mechanisms A, B and C shown respectively in FIGS. 2A, 2B and 2C.

The device thus supplies treated and relatively bubble free water to the cold water tempering valve supply (10). Therefore the downstream pipework is effectively treated and all water is treated.

Solenoids

The invention includes up to 2 solenoids, as shown in FIG. 3. The solenoids control flow of water through the device and allow it to operate in either “faucet open” mode or “holiday” or “run down” mode.

In faucet open mode the mains water solenoid (27) is opened and closed by the flow switch (11) that starts the device when the faucet is opened and stops the device when the faucet is closed. In faucet open mode the hot water solenoid (26) is closed to stop any back flow into the device, for example from a hot water tank (2) through a hot water return port (25). In holiday mode the mains water solenoid (27) remains closed at all times. Operation of the device is controlled by the rundown timer (28). When the rundown timer (28) activates the device, the hot water solenoid (26) opens and allows hot water to be drawn into the device through the hot water return port (25) from the hot water tank (2) and the water is treated by the device then recirculated through the hot water tank (2).

Flow Switch

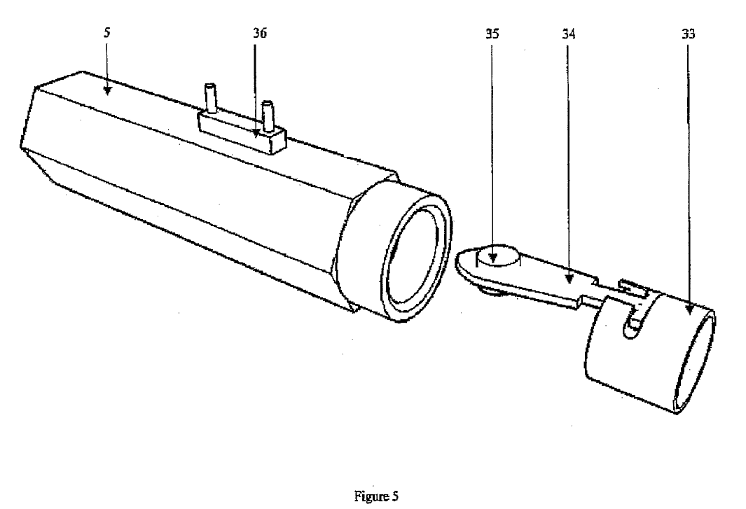

FIG. 5 shows the configuration of the flow switch (11) within the device. The flow switch has been designed as an integral part of the invention. It consists of four parts. The mounting sleeve (33) fits inside the mains supply pipe (5) and locates the paddle (34) upon which the magnet (35) is mounted. The paddle pivots when water flows and the magnet is moved closer to the reed switch (36) mounted on the exterior of the mains supply pipe (5). The change in proximity between the magnet (5) and the reed switch (36) opens and closes the electrical contacts in the reed switch. This pivot design allows debris to pass through the flow switch without fouling the moving parts.

By adding electronic intelligence, including a rundown timer (28) and relays to the flow switch circuit, the device is able to self adjust and alternate between two modes of operation depending on age of the hot water system. The rundown timer (28) in the device starts each time the flow switch (11) contacts open as the faucet (3) closes during normal operation. When the time interval between faucet openings is greater than the rundown timer (28) setting the device changes to holiday mode operation until a faucet is opened again. Holiday mode means that the device operates periodically (or example for 5 minutes every 48 hours) to regularly treat stored water in a tank (for example hot water tank (2)).

The device can be connected to mains power independently from the hot water system so that ongoing water treatment can occur irrespective of the tank temperature. Therefore purification can occur even when the dwelling is unoccupied and the hot water system is turned off for extended periods. During the 5 minutes of operation the rundown timer (28) opens the hot water solenoid (26) and operates the water pump (12), oxidant emitters (29), gas solenoid (30) etc. The device draws water out of the hot water tank (2) through the recirculation suction port (31), treats the water and returns the treated water to the hot water tank (2) through the recirculation ream port (32).

An additional control mechanism within the device is a self resetting thermal cutout (37) which senses the water temperature at the recirculation suction port (31) and cuts the electrical power to the device whenever the temperature exceeds a preset level (for example 60 degrees C.).

Single Port Connection

FIG. 6 shows the configuration of the single port adaptor (39), which is an integral part of the device and enables it to connect to a single tank port (17) on a tank. This is delivery mechanism B previously described and shown in FIG. 2B. This allows the device to be fitted by OEM's (original equipment manufacturers) or to be retrofitted with or without solar panels, in the case of hot water systems. The use of a single port, facilitates connection to all pressure storage hot water systems.

When the faucet (3) is opened, treated water and undissolved oxidant bubbles (18) exit the device through the sloping outlet port (15) and enter the right angle port (20) of the single port adaptor (39) turn vertically upwards and enter the hot water tank (2). When solar panels for example are included in the system the single port adaptor (39) enables treated water to be supplied to the solar panel. Any entrained undissolved oxidant bubbles (18) are separated as the water turns vertically downwards before exiting via the treated water to the solar panel port (38).

When the dwelling is unoccupied and the device is in holiday mode the device treats the water stored in the hot water tank (2). The water entering and treated water exiting the device flow through the single port adaptor (39). Hot water is drawn into the device by the water pump (12) after exiting the hot water tank (2) through the flexible tube (22) and entering the device through the hot water return port (25). The treated water exits the device through the outlet port and re-enters the hot water tank (2) through the right angle port (20).

Pump and Motor

The water pump (12) and electric motor are designed in the innovation so that the water pump (12) has adequate pressure development to overcome the system pressure which includes the venturi pressure drop and high tank pressure caused by thermal expansion. This enables the venturi to draw air at atmospheric pressure into the emitter cell, oxidize it and then introduce the oxidant gas into the pressurised hot water system.

For example when thermal expansion occurs as the water heats, the tank pressure will rise until the tank pressure relief valve limits the pressure to, for example 850 kpa. In holiday mode this system pressure is maintained as well as the pressure drop through the venturi (14) and must be overcome in order to introduce oxidant gas. To achieve this the water pump (12) must produce an outlet pressure not less than 1450 kpa while maintaining a 6 l/min flow rate.

Potted Shell

FIG. 7 shows how the oxidant emitters and associated electronic components are designed in the innovation so that they are integrated into the potted shell (40) or outer shape of the device. FIG. 7 shows the inside of the potted shell. The outside of the potted shell may be relatively smooth, or any other shape desired to suit market and customer needs.

This design provides the device with several advantageous features. Improved safety results, where all of the high voltage components are encapsulated protecting them from ingress of water and also giving protection to people from electrical components. Improved reliability results, due to the encapsulation of all electronic components.

Feedback Signal

FIG. 7 also shows the feedback signal cable (41) from the potted shell (40) of the device. The device is designed to give two types of feedback to an external monitor for example in an occupied area of the building to assure the occupants that the device is performing properly. The first signal confirms the general operation (starting and stopping each time a hot water faucet is opened and closed) of the device and is generated from the relay which is operated by the flow switch (11). This signal is created by the use of a double pole relay where one set of contacts are used as a make or break switch in the signal circuit. The second signal confirms the operation of the oxidant emitter within the device. This signal is created by using the capacitance voltage of the high voltage power supply to illuminate a neon. By using the light to signal a light dependant resistor, a signal is generated which directly monitors the high voltage circuit including the emitter and power supply.

Chemical Method

The device includes an oxidant emitter 29. This may comprise an ozone generator which creates ozone gas which is injected into the water through the venturi. Or it may comprise an advanced oxidation generator, such as is described in any patents associated with Ozone Manufacturing, including Australian patent applications 2002344695, 2002257378, 2002336795 or related patents lodged in other countries.

Benefits Summary

The device can treat the internal surfaces of pipes and tanks as well as the water in the pipes and tanks to control surface pollutants and waterborne pollutants.

Oxidants produced by the device enter the tank in two forms. They enter as dissolved oxidants in the water which treats all of the wetted tank surfaces. They also enter as un dissolved oxidant bubbles which give added treatment to the water as they rise to the surface of the water.

The device treats the internal surfaces of all pipework, faucets and shower heads in the hot water system and because both the water entering the hot water tank (2) to be heated and the cold water entering the cold water tempering valve supply (10) are treated, no untreated water enters the hot water system.

The device is designed to treat the contents of the hot water tank (2) irrespective of whether hot water is being used or not and also during holiday time when the water heater may be turned off and the stored water may cool and possibly stagnate.

The device enables energy efficient hot water systems to be designed and utilised. In a conventional hot water system for example, the water must be heated (for example to a minimum of 60C.) in order to kill legionella and then reduced in temperature by using a tempering valve (for example to a maximum of 45C.) in order to reduce scalding. For solar systems, in many parts of the world, local sunlight enables the 45C. temperature to be achieved with solar energy alone, but additional electric or gas boosters are required to reach 60C. Therefore by utilizing the invention to control legionella, the water need only be heated to 45C. for example, thus avoiding the need for a tempering valve, and also avoiding the need for electric or gas boosters.

Related Inventions

Point of entry to buildings: In high density residential situations the device could be located where the municipal mains supply enters the property immediately downstream of the water meter. In this situation all of the water entering the property is treated. The device can be installed into the mains pressure system with or without a residence tank, depending on the mains water quality. From FIG. 3 the supply is connected to the mains supply pipe 5 and the plumbing to the dwelling is connected to the outlet port 15. The other ports on the device would be inactive and plugged. In low density residential situations the device could be located where the municipal mains supply enters the building so that water which is used for watering gardens etc is not treated.

Non-pressurized systems: The device can also be used for treating water in non-pressurized systems including rainwater tanks, gravity feed hot water systems, swimming pools and spas. By adjusting the timing intervals of the “holiday mode” timer to suit the application, the device will recirculate and treat the stored water as required. In the rainwater tank situation there is an added benefit that the periodic water circulation reduces stagnation of the water. From FIG. 3 the suction line from the “tank” would connect to the water return port 25 on the device and would exit the device through the outlet port 15. In this application the other two ports would be inactive and plugged.

Soda beverage systems—syrup lines: The device can be used for cleaning syrup lines in carbonated drink dispensing equipment. Periodic cleaning/flushing is required to remove various residues from the internal surfaces of the syrup dispensing system including the lines, pumps and taps. To achieve this the device would be connected to a mains water faucet via the mains supply pipe 5 and discharge the treated water via the outlet port 15 into the syrup line system. In this application the two other ports would be inactive and plugged. The treated water flow rate could be set at a low flow rate to achieve the highest oxidant levels and minimize the amount of water consumed.

Beer line and Milk line systems, with or without recirculation; The device can be used for cleaning beer lines in beer dispensing equipment or milk lines in dairies. Periodic cleaning/flushing is required to remove various residues from the internal surfaces of the beer line system, for example, including the lines, FOB detectors, pumps and taps. To achieve this the device would be connected to a mains water faucet via the mains supply pipe 5 and discharge the treated water via the outlet port 15 into the beer line system. In this application the two other ports would be inactive and plugged. The treated water flow rate could be set at a low flow rate to achieve the highest oxidant levels and minimize the amount of water consumed.

An alternative method of cleaning the beer line system or milk dairy system would be to recirculate the treated water through an adjacent beer or milk line creating a closed loop so that only the water contained in the lines is used. To achieve this an appropriate filter would be added upstream of the device to remove any particulate matter. The beer line system, for example, would be filled with water and the device would be connected to a beer faucet via the mains supply pipe 5 and discharge the treated water via the outlet port 15 into the beer line system. Waste water treatment, for example carwash tanks: The device can be used to alleviate odour problems created by organic matter and bacterial growth in commercial carwash water tanks. This is a significant problem for both carwash users and surrounding residents. By adjusting the timing intervals of the “holiday mode” timer to suit the application the device will recirculate and treat the stored water as required. In the carwash tank situation there is an added, benefit that any undissolved oxidant bubbles which discharge through the surface of the water assist in odour control in the general tank area.

Washdown water purification; The device can be used to provide oxidized washdown water for a variety of applications. For example cleaning the internal surfaces of wine barrels and general washdown applications in the wine, meat and poultry processing industries. To achieve this the device would be connected to a mains water faucet via the mains supply pipe 5 and discharge the treated water via the outlet port 15. In this application the two other ports would be inactive and plugged.

Injecting fluids: The device can also be used to inject fluids other than gaseous oxidants into pressurized liquid systems, for example liquid injection in chemical and process Industry applications.

Although alternate forms of the invention have been described in some detail it is to be realised the invention is not to be limited thereto but can include variations and modifications falling within the scope of the invention.

1. A method of purifying water by a water purified to make it potable, located at the “point of entry” to a building (including house or office other premises), or within the building but other than at the “point of use” where the water exits the system to ambient pressure, the method comprising the steps of:
electrically producing oxidants which are mainly gases by passing molecules of air and/or water and/or water vapour through an oxidising chamber such as a corona discharge chamber; and
mixing these oxidants with the flow of water at an injection point, where the water at that injection point is at high pressure due to it being supplied through a pipe by a municipal water system, and where the injection point and the water pump are both located in the same by-pass loop, whereby the injection point delivers the oxidant at a constant rate irrespective of the variation of water pressure or water flow in the pipe either upstream or downstream of the water purifier.

2. A method of purifying water as defined in claim 1 wherein the oxidants include ozone.

3. A method of purifying water as defined in claim 1 wherein the oxidants contain oxygen and/or hydrogen atoms only, and include oxidants other than ozone, such as hydroxyl radicals or hydrogen peroxide.

4. A method of purifying water as defined in claim 1 wherein the oxidants are in the form of hydrogen peroxide and one or more of hydroxyl radicals, ozone, hydroxyl ions, atomic oxygen and atomic oxygen ions.

5. A method of purifying water as defined in claim 1 wherein ozone and hydrogen peroxide are produced in an oxidising chamber and then injected into water wherein hydrogen peroxide then acts as an intermediary and reacts with ozone to form hydroxyl radicals in the line downstream of the point of injection into the flow of water.

6. A method of purifying water as defined in claim 1 including the step of generating the oxidants by an electrical means only.

7. A method of purifying water as defined in claim 1 whereby the contact mechanism, which may-include a venturi, injects the oxidants into the water and operates at optimum efficiency across a wide range of conditions, including upstream water pressure conditions, downstream water pressure conditions and water flow rate conditions, and whereby that optimum efficiency is maintained when a downstream water tap or faucet is gradually opened or fully opened or gradually dosed or fully closed.

8. A method of purifying water as defined in claim 7 wherein water flows through a venturi or through an internal venturi bypass, or through both, inside the purifier device, and thus an optimum water flow rate passes through the venturi.

9. An internal bypass arrangement as defined in claim 8 whereby water can flow through the bypass loop in either a forward direction or a reverse flow direction or may not flow through the bypass at all but instead be static.

10. An internal bypass arrangement as defined in claim 8 whereby the bypass acts as a water/gas separator to reduce gas recirculating to an internal water pump.

11. A method of purifying water as defined in claim 1 but where in addition to operating at mains water pressure at the injection point, the device can alternatively inject at a lower water pressure or ambient water pressure.

12. A method of purifying water as defined in claim 1 wherein there is means of transporting the oxidants into a storage tank without any water actually flowing into the tank

13. A method of purifying water as defined in claim 1 wherein the device includes a water flow switch and therefore the device starts electrically and starts producing oxidants when a water tap or faucet is operated, and where that flow switch may include a pivoting paddle which moves when water flow and is resistant to the presence of debris in the water.

14. A method of purifying water as defined in claim 1 wherein the device includes an internal high pressure water pump within the device, to overcome the system pressure including that of the contact device, and to allow recirculation when mains water is not exiting the system and to allow operation of the internal bypass loop.

15. A method of purifying water as defined in claim 1 wherein the cumulative purification time is increased by including a rundown timer with a recirculation function so that after a water tap or faucet is closed, the unit continues to produce oxidants and continues to inject these into the water, for a period of time.

16. A method of purifying water as defined in claim 1 wherein the device recirculates and purifies stored water at timed intervals to maintain the purity of the stored water even when water is not being consumed or the water tap or faucet is not being used.

17. A method of purifying water as defined in claim 1 which includes signalling to a user interface the status of the oxidant generation system and correct electrical operation.

18. A method of purifying water as defined in claim 1 which includes transfer of the oxidised water into a vessel or tank, where prior to entering the tank or after entering the tank, excess oxidant in the gas phase is vented or degassed from the system.

19. A method of purifying water as defined in claim 1 which includes transfer of the oxidised water into a vessel or tank, wherein treated water can recirculate from the device to the tank and back to the device again, through a single port into the tank whereby water can enter the tank through that port in one direction and exit that port to the oxidation device in the other direction, by an arrangement of a pipe inside a pipe.

20. A method of purifying water as defined in claim 1 wherein Lime/Scale/Salts build-up is controlled in hot water systems, which results in reduced regular servicing, increased parts life and improved heating efficiency including a reduction in energy usage.

21. A method of purifying water as defined in claim 1 wherein Corrosion is controlled in water systems due to a reduction in scale and bio-film in the water system.

22. A method of purifying water as defined in claim 1 wherein there is increased oxygenation of the water with benefits including a perceived taste improvement and improved water clarity.

23. A method of purifying water as defined in claim 1 wherein Legionella and other bacteria, viruses and protozoa are controlled in water systems.

24. A method of purifying water as defined in claim 1 wherein odours are controlled in tap water.

25. A method of purifying water as defined in claim 1 wherein air is dried and then passes through an oxygenator and/or compressor and is then humidified before passing through an oxidising chamber.

26. A method of purifying water as defined in claim 1 wherein, said apparatus includes means of micro-flocculating salts in the water, and either causing those salts to exit the system when a tap or faucet is opened and/or passing these salts through a filter, thus reducing the concentration of salts in the water.

27. A method of purifying water as defined in claim 1 wherein the oxidation emitters which create a corona discharge or similar field, include one or more conductive electrodes which are encapsulated or laminated by dielectric material so that the electrodes are not exposed or adjacent to the gas flow.

28. A method of purifying water as defined in claim 1 wherein the entire device is potted in a material such as epoxy or urethane, or the oxidising chamber component of the device is so potted, thereby providing protection of internal parts from water of dust or human contact.

29. A method of purifying water as defined in claim 1 which may include the following applications: hot water treatment where the heating system is either by storage tank or instantaneous system or continuous system or solar, tempered hot water systems where some cold water bypasses the heating system in order to avoid downstream scalding, rainwater tank treatment, distribution pipe treatment, drinking water treatment, general point of entry treatment, swimming pool treatment, pressure header storage tank treatment, soda beverage systems and syrup lines, beer and milk line systems, waste water treatment such as carwash tanks, washdown water purification, injection of fluids, and other applications.

30. A method of purifying water as defined in claim 1 wherein water is treated in a tempered hot water system and the water treated includes water which enters a storage tank and also includes water which bypasses the water tank and enters a tempering valve, and thus ensures that all water is treated which may eventually exit the system and also ensures that all water transport pipes have their surfaces treated by oxidants.

31. A method of purifying water as defined in claim 1 which may include an advanced oxidation generator device as described in any of Australian patent applications 2002344695, 2002257378 or 2002336795 and their respective patents lodged in other countries.
